(19) United States
(12) Patent Application Publication
(10) Pub. No.: US 2003/0100307 A1
(43) Pub. Date: May 29, 2003

(54) Automatic service handoff method and apparatus

(75) Inventors: Peter Wolochow, Portland, OR (US); Sandip H. Mandera, Portland, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 09/995,432

(22) Filed: Nov. 27, 2001

(51) Int. Cl. H04Q 7/20

(52) U.S. Cl. 455/440; 455/445; 455/456; 455/525

(57) ABSTRACT

A system, apparatus, and method to support automated service handoff operations for mobile devices are disclosed. The system includes a mobile device, a location determination entity for the mobile device, and a registry which operate to automatically bind available services, published to the registry by service providers to the mobile device. Automated binding and hand-off occurs in response to a query from the mobile device to the registry whenever the mobile device changes location, the Qos degrades, or the signature changes. The method includes sending the query (including preferred services) to the registry from the mobile device, receiving a response from the registry regarding matching services which are available for binding, and binding the available services to the mobile device.

### FIELD OF THE INVENTION

The present invention relates generally to the acquisition and use of services available to mobile devices. More particularly, the present invention relates to the acquisition and use of networked services and/or peripherals in conjunction with a mobile device according to preselected user preferences as the location of the device changes over time.

### BACKGROUND INFORMATION

Mobile computing devices are gaining in popularity due to their increased portability and capability. While such devices are often constructed so as to emulate the function of full-size (e.g., desk top) computing platforms, they have been miniaturized to the point that the use of various conventional peripheral services, such as printers, scanners, and bulk storage systems, is often limited by the location of the device.

For example, a personal digital assistant (PDA) user may wish to print out a mailing label to attach to a package being sent to a friend. Using an infra-red link on the PDA, a printer in his home might be employed for the task. However, if the user is at a nearby post office, a line-of-sight infra-red link will be useless. In this case, a post office printer might be accessible, but to print the label the user will likely have to log on to the Internet, connect to the post office web site, address the post office printer (if this is even possible), and send the information to the printer. It would probably take less time, and be more effective, to simply phone home and recover the information manually.

Even when the configuration of a mobile device can be readily changed to accommodate various peripherals, other problems may arise. For example, software applications or drivers may have to be loaded for a similar service bound to the mobile device and accessed from a new location. If a cellular phone user regularly moves between work and home, for example, it is inconvenient to remember to change the phone configuration for the printer at each location (along with other useful peripherals, such as a scanner, digital camera, etc.) each time the location changes. One undesirable result of a failure to timely and correctly change peripheral services might be that confidential printouts designated for the office are printed out in the home.

Finally, the user of a mobile computing device usually has a fixed number of services that are used throughout the day, and usage preferences that relate to each of them. However, it may be difficult to remember all of the nuances of use for each peripheral, or even that certain services are required, each time the user changes the location of the device.

Thus, there is a need in the art for a method and apparatus that operates automatically to detect and use services, such as networked peripheral services, as they become available to a mobile device user. The detection and acquisition (i.e., binding services to the mobile device) of such services should be accomplished without requiring the user to remember all of the services typically used in conjunction with a particular mobile device, preferences with regard to individual services (such as color versus grayscale printing, for example), or which peripherals are located in a particular geographic area. Further, the method and apparatus should be able to update the services available to a particular mobile device (e.g., release non-preferred services, and bind preferred services) based on a change in location, or the passage of time, possibly in conjunction with the quality of service provided.

### BRIEF DESCRIPTION OF THE DRAWINGS

FIG. 1 is a block diagram of an automated service handoff system, according to an embodiment of the present invention;

FIG. 2 is a block diagram of a mobile device that supports automated service handoff operations, according to an alternative embodiment of the present invention; and

FIG. 3 is a flow chart illustrating a method of automating service handoff operations according to an alternative embodiment of the present invention.

### DESCRIPTION OF THE PREFERRED EMBODIMENTS

In the following detailed description of the invention, reference is made to the accompanying drawings which form a part hereof, and in which are shown by way of illustration, and not of limitation, specific embodiments in which the invention may be practiced. In the drawings, like numerals describe substantially similar components throughout the several views. The embodiments illustrated herein are described in sufficient detail to enable those skilled in the art to practice the invention. Other embodiments may be utilized and derived therefrom, such that structural and logical substitutions and changes may be made without departing from the scope of the invention. The following detailed description, therefore, is not to be taken in a limiting sense, and the scope of the invention is defined only by the appended claims, along with the full range of equivalents to which such claims are entitled.

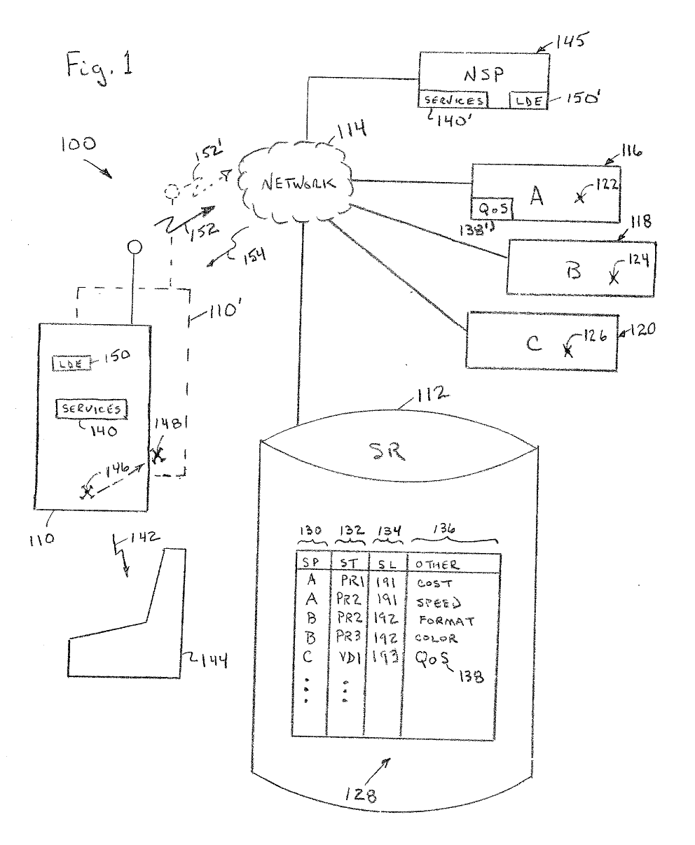

FIG. 1 is a block diagram of an automated service handoff system, according to an embodiment of the present invention. The automated service handoff system 100 includes a mobile device 110 capable of communicating with a service registry 112, similar to, or identical to a Universal Discovery Description and Integration (UDDI) repository, or any other extensible markup language (XML)-based registry. Communication may be accomplished using a wireless interface and/or a network 114, such as a global telecommunications network, or a computer network, including the Internet.

A plurality of service providers 116, 118, and 120 (which may be a physical business, an Internet web site, a computer, etc.), each associated with a service location 122, 124, and 126, respectively, and capable of communicating with the registry 112, may publish the services they provide to the registry 112. The published services may be stored and maintained within the registry 112 in the form of a list of available services 128. Such “services” may include the provision and/or operation of printers, scanners, cameras, other computers, storage, and any other peripheral or device which may be bound to the mobile device 110 and commanded to perform some action on behalf of the mobile device user. For example, the list of available services 128 may include a service provider identifier 130 (e.g., the identifier might be “A” for service provider 116, “B” for provider 118, and “C” for provider 120); a service type 132 (e.g., service provider A may have printers of type “PR1” and “PR2”; provider B might have printers of type PR2 and “PR3”; and provider C might have a read/write disk drive of type “VD1”); a service location 134 (e.g., provider A might be associated with the location 122, provider B with the location 124, and provider C with the location 126). The list 128 may also include other information 136 for each of the services published by the service providers 116, 118, and 120. The other information 136 might include, for example, the cost of the service provided, the speed of the service, the data or communication format required by the service, whether or not the service operates in color or black/white, display resolution required by the mobile device, user's preferred language, security and reliability of the service, revision level of the service software or hardware, and/or some form of Quality of Service (QoS) parameters.

The term “Quality of Service” (QoS), as used herein, may be used to indicate any aspect of a service that can be described by words or numbers, and which affects, directly or indirectly, the quality of service a user of such services may experience. For example, the QoS parameters 138 for a particular printer service might include or characterize one or more of the following aspects of printing services: printer operation status (ON/OFF/OUT OF PAPER), printer queue status (XXX jobs pending), average job length (XXX pages or XX minutes), estimated time to service an immediate user request (XX minutes), bandwidth limit (XXX Kbytes/second), type of paper, automatic features it may offer, etc. Examples of QoS parameters 138 for a storage device might include: operational status (ONLINE/BUSY/OFFLINE), space available (XXX Gbytes), bandwidth limit (X.X Mbytes/sec), etc. The QoS parameters 138 for service provider 166, for example, may be maintained by the service provider at the provider's location 122, and sent to the registry 112 whenever services are published to the registry 112. Alternatively, the QoS parameters 138 may be maintained by the registry 112 within the list 128, as they change or via queries from the mobile device and/or registry.

The mobile device 110, which may be a cellular telephone, a personal digital assistant (PDA), a personal internet client, a two-way pager, or some other mobile two-way communications device, includes a list of preferred services 140, typically stored in a memory. These services 140 may be pre-programmed by the manufacturer of the device 110, manually selected by the user of the device 110, or downloaded to the device 110 (e.g., using a wireline or wireless link 142, for example) from a personal computer 144 or a network service provider 145. Thus, the system 100 may also include a computer 144 capable of being communicatively coupled with the mobile device 110 and transmitting the list of preferred services 140 to the mobile device 110. The mobile device 110 is associated with a location 146, which may be a GPS location, a location provided by a packet radio service, a wide area network (WAN) cell location, a street address, a named location (e.g., LAX Airport or University Campus), or even a group of locations (e.g., lab, office, and environmental chamber). Typically, a separate list of preferred services 140 will be maintained by the device 110 for each location. As the mobile device 110 moves about, or as time goes on, and the current location 146 associated with the mobile device 110 changes (e.g., moving from location 146 to 148), the mobile device 110 will make use of a location determination entity 150 to make a decision as to whether the new location 148 is indeed different from the previous location 146. If so, the new location 148 will be selected as the current location of the device 110, and a query 152 including the location 148 for which services are to be provided may be launched toward the registry 112 from the mobile device 110 to determine which services in the list of available services 128 are available for use with the mobile device 110 at the new (now current) location 148. Available services that correspond to the location 148 may then be bound to the mobile device 110 for use in place of similar or identical services corresponding to the previous location 146, provided that a sufficient number of the service parameters (e.g., service provider, service type, other parameters, etc.) correspond to those listed in the preferred services list 140, the structure of which may be identical to, or similar to the structure of the available services list 128. Services may be bound to the mobile device as part of the response 154 to the query 152 by the registry 112, or following a simple acknowledgement response 154 to the query 152 by the registry 112.

The location determination entity 150 may be an integral part of the mobile device 110, or may be maintained by a separate service provider 145 that monitors the location 146, 148 of the mobile device. In any case, the location determination entity 150 should be capable of being communicatively coupled to the mobile device 110, and may be a software program, a set of instructions stored in firmware, or a hardware circuit module, or any combination of these, and may include a global positioning system (GPS) receiver.

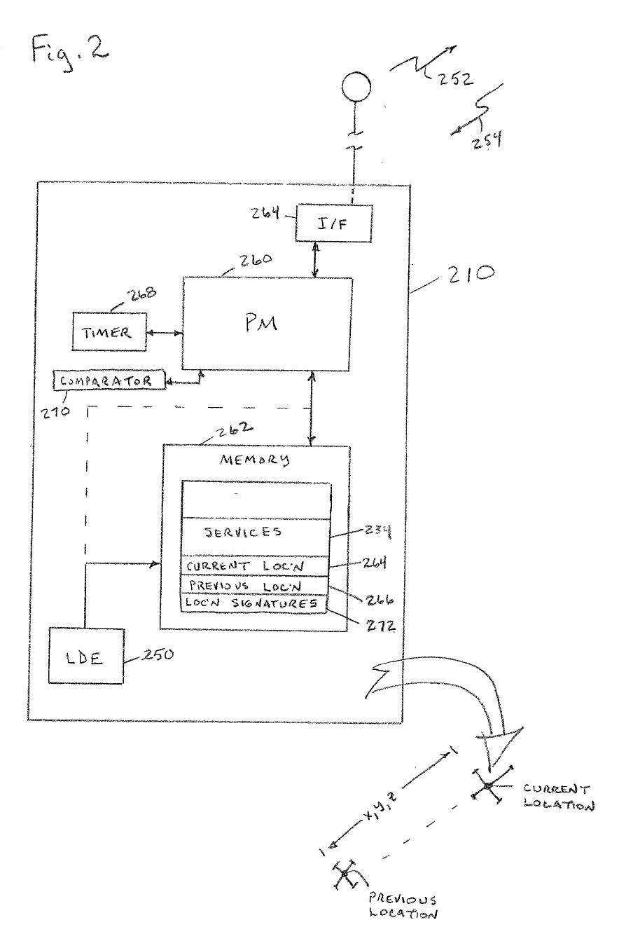

FIG. 2 is a block diagram of a mobile device that supports automated service handoff operations according to an alternative embodiment of the present invention. The mobile device 210 may include a processor module 260 communicatively coupled to a local memory 262, which is capable of storing a list of preferred services 234, a current location of the mobile device 264, and a previous location 266 of the mobile device 210. The device 210 may also include a wired or wireless communications medium interface 264 communicatively coupled to the processor module 260 and capable of being communicatively coupled to the service registry (see FIG. 1).

As discussed above, the mobile device 210 may send a query 252 (including a service location associated with the current location 264 of the mobile device 210) and at least one member of the list of preferred services 234 to the service registry. The service location may be the same as the current location 264 of the mobile device 210, or may be related, directly or indirectly, to the current location 264 of the mobile device 210. For example, if the current location 264 of the mobile device 210 is “123 AnyStreet”, the service location might be simply “AnyStreet”. Similarly, if the current location 264 of the mobile device 210 is “123.45 LONG, 67.89 LAT”, then the service location might be “123.XX LONG, 67.XX LAT”. As another example, if the current location 264 of the mobile device 210 is “Physics Room University Campus”, the service location might be “City, State” of the university campus. Generally, the service location sent by the mobile device 210 in its query 252 will be specified no more precisely than the precision with which the current location 264 is known, and as a practical matter, the service location will usually be specified with some lesser degree of precision than that of the current location 264, to ensure that some number of preferred services 234 will be available from the registry for binding to the device 210.

As noted above, the mobile device 210 may also include a location determination entity 250 capable of determining the current location 264 of the mobile device 210. There are many different mechanisms which may be used to trigger a query 252 from the mobile device 210, based on a change in location as resolved by the location determination entity 250 or change in the signature preferences. For example, the mobile device 210 may include a timer 268 coupled to the processor module 260 for determining a polling or service query update interval. If this is the case, then the timer may be set by the mobile device user, the registry, or a network service provider to initiate a location determination by the processor module 260 and/or the location determination entity 250 periodically, with a new query 252 being sent if the current location differs from the previous location by some preselected amount, such as X feet, or Y miles, or Z seconds of longitude or latitude, for example.

Once the query 252 is launched, and a response from the registry 254 is received, the mobile device 210 may also include a comparator 270 coupled to the processor module 260 for determining whether at least one of the requested number of services (from the preferred services list 234) are available for binding to the mobile device 210. The comparison may be a loosely made, or very specific (e.g., filtered according to specification set up by the mobile device user, the registry, and/or network service providers). For example, a laser printer having color capability, with a certain resolution and output speed may be requested. On the other hand, the query 252 may be formatted such that any text printer will suffice. Such queries and responses are well known to those skilled in the art of programming. In any case, the comparator 270 may take the available services offered in the response 254 to make a comparison with the requested preferred services in the query 252, for ultimate selection by the mobile device 210 for binding.

The mobile device may also store a plurality of location signatures 272 in the memory 262. As used herein, a “signature” is a set of preferred services that are to be bound to the device 210 whenever a particular location, or set of locations, are currently associated with the device 210. For example, if the user of the device 210 commutes between work and home, the location “work” may have one signature, and the location “home” may have another signature. The work signature may include a desktop laser printer, digital camera, and scanner located in the user's office. The home signature may include an in-home ink jet printer, a camera located at the front door of the user's home, and a scanner located in the user's photographic darkroom. However, when the user travels to his home office in New York city, the “travel” signature may include a printer and fax machine located at a particular hotel in New York, associated with several locations, such as an “AIRPLANE”, an “AIRPORT”, and a “HOTEL.

It should be noted that the location determination entity 250, the processor module 260, the timer 268, and the comparator 270 may all be implicitly characterized as “modules” herein. Such “modules” may include hardware circuitry, such as a microprocessor and memory, software program modules, or firmware, and various combinations thereof, as selected by the architect of the system 100, and appropriate for particular implementations of the invention. It should also be noted that the mobile device 110 may use a local registry to store its signature and other local services.

One of ordinary skill in the art will understand that the system and apparatus of the present invention can be used in other applications, and thus, the invention is not to be so limited. The illustrations of a system 100 and a mobile device 110, 210 are intended to provide a general understanding of the structure of the present invention, and are not intended to serve as a complete description of all the elements and features of automated service handoff systems and mobile devices which might make use of the structures and elements described herein. Such systems and devices may further be included as sub-components within a variety of electronic systems, such as televisions, cellular telephones, personal computers, personal radios, automobiles, aircraft, and others.

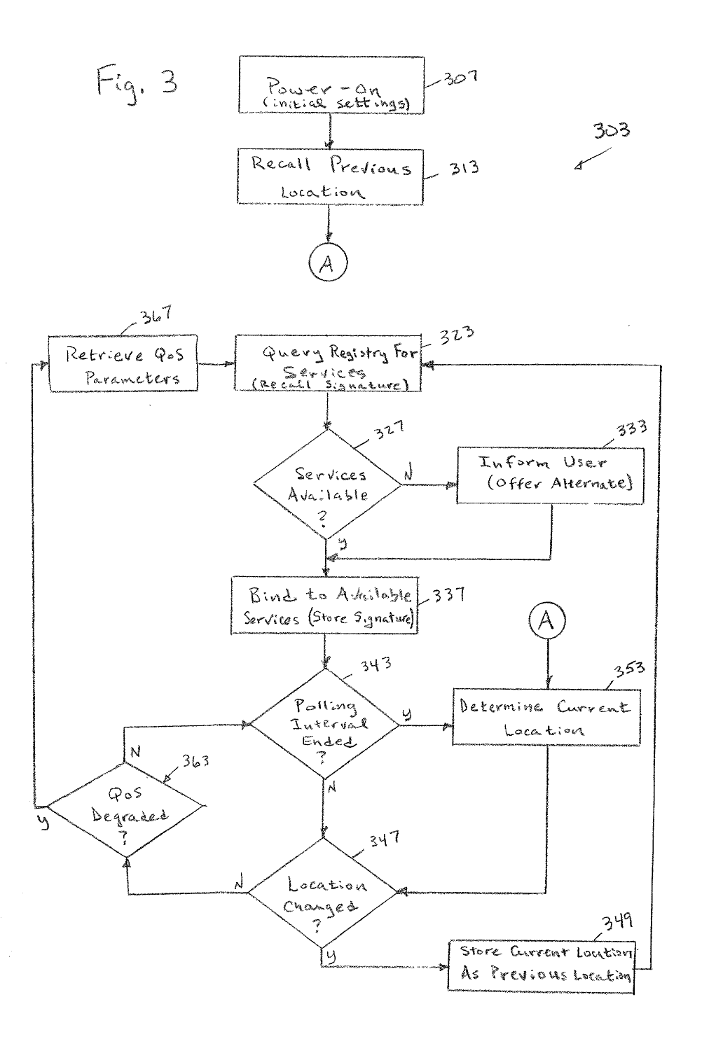

FIG. 3 is a flow chart illustrating a method of automating service handoff operations according to an alternative embodiment of the present invention. The method 303 may begin with applying power to a mobile device at block 307. If this is the very first time the device has been turned ON, then initial settings may have to be retrieved, including a pseudo-“previous location”; perhaps the location of the factory where the device was manufactured, or some other default location. The pseudo-previous location, or a real previous location can then be recalled at block 313.

The current location of the mobile device may then be determined at block 353, and if the location of the mobile device has changed (i.e., the current location is, in some form, not the same as the previous location) as determined at block 347, the current location is stored as the previous location at block 349. It should be noted that the current location may be determined at block 353 by querying a registry, such as a UDDI registry, a universal plug and play (UPnP)-based discovery mechanism (e.g., a GPS receiver), querying a mobile device internal location determination entity, and/or querying a registry to detect a change in location. A query including a service location associated with the current location (and at least one selected member of the list of preferred services associated with the mobile device) may then be sent to the service registry at block 323.

Alternatively, if one or more signatures are stored, either in the mobile device or elsewhere (e.g., at a network service provider), the current location may have been associated with one of the stored signatures, and the selected signature associated with the current location may be recalled, such that the associated group of services may be requested via the query at block 323. When the response is received from the service registry, it should include at least one selected member of a list of available services maintained by the service registry.

If some (or all) of the requested preferred services are not available for binding to the mobile device, the user of the device may be informed of that fact at block 333. The user of the mobile device may manually select such alternative services, or a program module acting as a filter and located within the mobile device may be used to select/reject alternatives. It is even possible that one or more alternatives to the non-available requested services will be offered to the user of the mobile device via the response from the registry at block 333. The mobile device will then be bound to the available services maintained by the registry that match the query criteria (including available alternative services selected by the user of the device) at block 337, as determined by the comparator in the mobile device, or possibly, the registry. If desired, the mobile device may be used to store a signature for the current location and the corresponding services that have been bound to the mobile device at the current location at block 337. As time goes on, a plurality of location signatures that cover the normal range of movement for the mobile device may be stored.

As mentioned above, various types of events can be used to trigger a determination of whether the mobile device has moved to a new location, such as a timeout event from a countdown timer, or an alert from a GPS monitoring device. For example, one possibility might be that the timer 268 (see FIG. 2) is set up to count down a polling interval, such that when the interval ends (at block 343), the current location is determined at block 353. Even if the polling interval has not been concluded, some other trigger event, such as entry into another WAN cell, may cause the system or mobile device to conclude that the location of the mobile device has changed at block 347.

In any case, when it has been determined that the position of the mobile device has changed by some preselected distance, change in signature preferences, or that the current location differs in some other way from the previous location (e.g., a new WAN cell has been entered), the current location will be stored as the previous location at block 349, and a query, including the service location associated with the new current location and one or more members of the list of preferred services in the signature will be sent to the service registry at block 323.

As mentioned previously, each service published to the registry may be associated with one or more QoS parameters. Even though the location of the mobile device has not changed at block 347, and the polling interval has not ended at block 343, if it is determined that the QoS for one of the bound services has degraded in some fashion at block 363, the QoS parameters for that service will be retrieved at block 367, and a query for binding alternative services may be sent to the registry at block 323.

The determination of degradation in QoS may be made directly by the mobile device, such as when a printer no longer responds to service requests, or indirectly, via an alert supplied to the mobile device from the registry or the service provider. Of course, as explained above, QoS aspects that can be reported to or monitored by the mobile device may include information regarding whether the service is responding at all, whether the response is significantly delayed, or even whether the response from a service is not as expected (e.g., the wrong data format has been received from the service, or a new printer has been installed and uses a different configuration language), etc. In this case, a query sent to the registry from the mobile device may direct that the QoS parameters for the service be updated, or merely investigated. Alternatively, or in addition, the QoS degradation findings may be reported directly to the service provider by the mobile device, or the registry, or both.

Thus, if it is determined that the QoS associated with one or more members of the list of available services has degraded, an alternative available service may be bound to the mobile device. This may include retrieving the QoS parameters associated with the member(s) of the list of available services, either from the registry, or the service provider.

The apparatus and method of the invention provide a seamless service handoff mechanism as perceived by the mobile device user. Thus, the user no longer needs to remember to change services every time the location of the mobile device changes. In addition, when the QoS for a particular service degrades, a new service may be bound to the mobile device in an automated fashion. For example, the user of the mobile device may specify backup or default services that may be bound upon QoS degradation or whenever preferred services for a particular location or signature are not available. The automated service handoff mechanism of the present invention also provides the ability to specify the level of service provided, with minute detail, if desired (e.g., binding to a laser printer with color capability and A4 paper supplied), giving even more flexibility and the opportunity for tailoring services to the needs of the most discriminating user.

Although specific embodiments have been illustrated and described herein, those of ordinary skill in the art will appreciate that any arrangement that is calculated to achieve the same purpose may be substituted for the specific embodiments shown. This disclosure is intended to cover any and all adaptations or variations of the present invention. It is to be understood that the above description has been made in an illustrative fashion, and not a restrictive one. Combinations of the above embodiments, and other embodiments not specifically described herein will be apparent to those of skill in the art upon reviewing the above description. The scope of the invention includes any other applications in which the above structures and methods are used. The scope of the invention should be determined with reference to the appended claims, along with the full range of equivalents to which such claims are entitled.

What is claimed is:

1. An automated service handoff system, comprising:
a service registry including a list of available services;
a mobile device associated with a current location, wherein the mobile device includes a list of preferred services, wherein the mobile device is capable of sending a query including a service location associated with the current location and at least one selected member of the list of preferred services to the service registry, and wherein the mobile device is capable of receiving a response to the query from the service registry including at least one selected member of the list of available services; and
a location determination module capable of determining the current location of the mobile device and capable of being communicatively coupled with the mobile device.

2. The automated service handoff system of claim 1, wherein the service registry is an extensible markup language-based registry.

3. The automated service handoff system of claim 1, wherein the list of available services includes a service provider, a service type, and a service location for the at least one selected member of the list of available services.

4. The automated service handoff system of claim 1, wherein the mobile device is capable of being bound to the at least one selected member of the list of available services.

5. The automated service handoff system of claim 1, wherein the location determination entity is included in the mobile device.

6. The automated service handoff system of claim 5, wherein the location determination entity includes a global positioning system receiver.

7. The automated service handoff system of claim 1, wherein the mobile device includes a memory in which a plurality of location signatures are stored.

8. The automated service handoff system of claim 1, further comprising:
a computer capable of being communicatively coupled with the mobile device and transmitting the list of preferred services to the mobile device.

9. The automated service handoff system of claim 1, further comprising:
at least one computer capable of publishing the at least one selected member of the list of available services to the service registry.

10. A mobile device, comprising:
a processor module;
a local memory communicatively coupled to the processor module and capable of storing a list of preferred services, a current location of the mobile device, and a previous location of the mobile device; and
a communications medium interface communicatively coupled to the processor module and capable of being communicatively coupled to a service registry for sending a query including a service location associated with the current location of the mobile device and at least one selected member of the list of preferred services to the service registry.

11. The mobile device of claim 10, further comprising:
a location determination module capable of determining the current location of the mobile device.

12. The mobile device of claim 10, further comprising:
a timer coupled to the processor module for determining a service query update interval.

13. The mobile device of claim 10, further comprising:
a comparator coupled to the processor module for determining whether a selected number of services are available for binding to the mobile device.

14. A method of automating service handoff operations, comprising:
determining a current location of a mobile device;
sending a first query including a service location associated with the current location and at least one selected member of a list of preferred services associated with the mobile device to a service registry;
receiving a response to the query from the service registry including at least one selected member of a list of available services maintained by the service registry; and
binding the at least one selected member of the list of available services maintained by the service registry to the mobile device.

15. The method of claim 14, further including:
determining that the mobile device has moved to a new current location; and
sending a second query including a service location associated with the new current location and the at least one selected member of the list of preferred services associated with the mobile device to the service registry.

16. The method of claim 15, wherein determining that the mobile device has moved to a new current location further includes:
storing the current location as a previous location;
determining the new current location of the mobile device; and determining that the new current location is not the same as the previous location.

17. The method of claim 15, further including:
determining that a polling interval time period has ended.

18. The method of claim 14, further including:
storing a plurality of location signatures in a memory of the mobile device.

19. The method of claim 18, further including:
determining that the mobile device has moved to a new current location; and
recalling a selected one of the plurality of location signatures associated with the new current location.

20. The method of claim 15, further including:
informing a user of the mobile device that the at least one selected member of the list of preferred services associated with the mobile device is not available for use by the mobile device.

21. The method of claim 20, further including:
binding an alternative available service to the mobile device.

22. The method of claim 14, further including:
determining that a quality of service associated with the at least one selected member of the list of available services included in the service registry has degraded; and
binding an alternative available service to the mobile device.

23. The method of claim 22, further including:
retrieving the quality of service associated with the at least one selected member of the list of available services.

24. The method of claim 23, wherein retrieving the quality of service associated with the at least one selected member of the list of available services includes:
retrieving the quality of service associated with the at least one selected member of the list of available services from the service registry.

25. The method of claim 23, wherein retrieving the quality of service associated with the at least one selected member of the list of available services includes:
retrieving the quality of service associated with the at least one selected member of the list of available services from a service provider associated with the
at least one selected member of the list of available services.
